(19) United States
(12) Patent Application Publication
(10) Pub. No.: US 2011/0120621 A1
(43) Pub. Date: May 26, 2011

(54) CONNECTION OF AERONAUTICAL STRUCTURAL ELEMENTS WITH OTHER THERMOPLASTIC ELEMENTS

(75) Inventor: Angeles SÁNCHEZ BLÁZQUEZ, Madrid (ES)

(73) Assignee: AIRBUS OPERATIONS S.L., Getafe (ES)

(21) Appl. No.: 12/710,985

(22) Filed: Feb. 23, 2010

(30) Foreign Application Priority Data
Nov. 26, 2009 (ES) 200931074

(51) Int. Cl. B29C 65/08; B32B 9/04; B32B 27/02

(52) U.S. Cl. 156/73.1; 428/411.1; 442/46

(57) ABSTRACT

Connection of elements (1) which form part of aeronautical structures, with said elements (1) being made from composite material, with other thermoplastic or reinforced thermoplastic elements (2) also pertaining to aeronautical structures, with said element (1) comprising at least one part of its structure made from thermoplastic material, with said part of thermoplastic material being arranged on the structure of the most superficial element (1) of composite material, with respect to the thermoplastic or reinforced thermoplastic element (2) with which it is to be connected, in such a way that the connection between the elements (1,2) is made by means of ultrasound welding without fusion, applying pressure and heat through friction of the surfaces of the elements to be connected (1,2) obtaining in this way a permanent connection of elements (1,2) making its extraction possible at the same time.

### SCOPE OF THE INVENTION

This invention refers to the connection through welding of elements which form a part of aeronautical structures, with said elements made in composite material, with other thermoplastic elements also pertaining to aeronautical structures.

### BACKGROUND TO THE INVENTION

Throughout history both the aeronautical industry and other industrial sectors have basically used three types of connection for assembling components: mechanical assembly as a permanent or non permanent type of connection; welded connections and adhesive connections as permanent types of connection.

The mechanical type assembly implies use of different methods of connection in order to keep two (or more) elements joined in a mechanical manner. In most cases the methods of connection imply the use of additional elements, known as attachments which are added to the elements to be assembled during the aforementioned assembly operation. In other cases the attachment mechanism implies a special configuration on one of the elements to be assembled, thus additional means of connection are not required. Mechanical connection methods are divided into two main classes: methods which permit disassembly and methods which create a permanent connection. Threaded attachments such as screws, bolts and studs are examples of the first method of mechanical connection whereas rivets provide a second example.

In the specific case of the aeronautical industry, the most commonly used materials to date, due to their resistance properties and low weight are composite materials also known as composites. Thus there are many elements of composite material which make up aeronautical structures and which include different parts or pieces which should be mounted and connected to each other, such that they are assembled in a non permanent manner, in order to permit subsequent repairs or substitutions. However, there are also composite material elements which make up aeronautical structures which include various parts or pieces which are very complex to manufacture in one piece, thus various parts are manufactured which will subsequently be permanently connected to make up the aforementioned elements. In the latter case, the permanent connections of the various parties or pieces which make up these elements may be carried out by means of welding or through the use of adhesives.

In order to join the elements of composite material which make up aeronautical structures comprising different parts or pieces connected in a permanent manner, the technique of welding may be used, which is usually obtained by casting part of the pieces to be joined or by casting an intermediate contributory material in such a way that a single final piece is created in which there is no physical discontinuity, with this connection being made by increasing the temperature of the surfaces of the parts to be welded once they have been placed in contact. It is also possible, as mentioned above, to make this connection by means of adhesive elements, using in this case a polymer which adheres to the parts to be connected.

Generally, there is no simple method of permanent connection which is the best choice for composite material elements which form part of aeronautical structures. However, connection by means of adhesives is usually a good method when connecting pieces of physically dissimilar material, or ones which are metallurgically incompatible, thermosetting polymers, ceramics, elastomers, very thin materials or small sized substrates. The problem raised by these connections using adhesives is that they take a long time to manufacture and this detracts from their industrial viability.

The problems associated with connections of a mechanical type are based on the considerable extra weight that additional parts (attachments) bring in order to make these connections, as they are generally metal and therefore have a high density which is counterproductive in the aeronautical industry in which the priority in new developments is a reduction in weight.

Of the aforementioned methods, that of mechanical type connections has the disadvantage of requiring threaded elements as well as modifications to the parts to be assembled (drilling or threading for example) as well as the need for more parts (screws, rivets, etc.) which always contributes to defeating the aforementioned priority of reduction in weight.

Furthermore, the connection method using adhesives does not attain sufficient resistance in the connection as welded connections would.

Due to the aforementioned reasons, the most economical method (in terms of materials and manufacturing costs) and the most reliable for making this type of connection between elements is welding.

The use of ultrasound welding for adhesive connections of composite material with a thermoplastic matrix which make up aeronautical structures comprising different parts or pieces is known in the art. However, connection through direct ultrasound welding is not feasible when it is used to connect elements of composite material with a thermosetting matrix or with a certain percentage of thermosetting in their composition.

The use of films of thermoplastic material is known in the state of the art with these being situated on composite material prior to the manufacturing process thereof, in such a way that following a curing process they are embedded in said composite material in order to make the connection with other thermoplastic elements using ultrasound welding. However, these layers or films had the disadvantage of sometimes becoming detached during the useful life of the composite material onto which they adhered. In addition, the connection obtained was deficient in terms of resistance and reliability, particularly when said connections were to be used in the field of aeronautics.

This invention is devised to resolve the aforementioned problem.

### SUMMARY OF THE INVENTION

Thus, this invention in a first aspect refers to the connection, through ultrasound welding, of elements which make up aeronautical structures, with said elements made in composite material, with other thermoplastic elements also pertaining to aeronautical structures.

According to the invention, the composite material element (termed substrate) includes a layer of thermoplastic material in the form of an interwoven mesh fabric with very small aperture size, known as carrier, with this layer of thermoplastic material (carrier) embedded in the structure of the most superficial layer of the composite material (substrate) with respect to the thermoplastic element (termed fitting) on which said element or substrate is to be connected. Furthermore, according to this invention, said fitting may also be made of thermoplastic material which contains some kind of reinforcement such as, for example, occurs with the composite material fittings with thermoplastic matrix reinforced with glass fibre.

In the particular case in question in which the element of the aeronautical structure or fitting to be joined to the other thermoplastic element (carrier) is metal in type, said element should include according to the invention, a layer of thermoplastic material with said layer adhering to the external surface of the aforementioned element or fitting with respect to the thermoplastic element (carrier) on which said element or substrate will be connected, so that it is once more similar to the case described previously.

Subsequently, the composite material element (substrate) with the layer of thermoplastic material (carrier) embedded in its structure is connected to the other thermoplastic or reinforced thermoplastic element (fitting) by means of an ultrasound welding process, having made a stable connection of a permanent type, but one which is at the same time extractable, and thus obtaining a unitary piece.

The fact that the element (substrate) includes, according to the invention, a layer of thermoplastic material (carrier) makes it possible to use ultrasound welding to connect it to another thermoplastic or reinforced thermoplastic element (fitting) as the elements to be connected are of the same kind.

Furthermore, in the case of composite material elements, as the layer of thermoplastic material is embedded in the structure of said element, the problem of detachment and unreliability of the connection is avoided by using ultrasound welding.

In addition, the mesh of thermoplastic material (carrier) enables the aeronautical structure element (substrate) to be joined to another element (fitting) to be thermosetting, thermoplastic or either a combination of thermoplastic material and thermosetting material.

According to a second aspect, the invention refers to a method for connecting the elements which make up aeronautical structures, with said elements made from composite material, with other thermoplastic or reinforced thermoplastic elements also pertaining to aeronautical structures. This method includes the following stages:
a) positioning of a layer of thermoplastic material (carrier) on the external surface of the element of composite material (substrate) prior to the manufacturing process of the composite material element (substrate) in such a way that following a curing process said layer (carrier) becomes embedded in the composite material (substrate);
b) preparation of the external surface of the composite material element (substrate);
c) connection through ultrasound welding of the layer of thermoplastic material of the aeronautical structure (carrier) with the other element (fitting) applying high frequency vibration with the assistance of a transducer;
d) if necessary, extraction of said fitting and ultrasound welding of said element in a new position.

Other characteristics and advantages of this invention are provided in the detailed description below of an embodiment illustrative of the objective in relation to the figures attached hereto.

### DESCRIPTION OF THE FIGURES

FIG. 1 shows a diagram of the connection of the elements which form part of aeronautical structures with other thermoplastic or reinforced thermoplastic elements, also part of aeronautical structures according to this invention.

FIG. 2 shows a detailed transversal section of the layer of thermoplastic material embedded in the external surface of the composite material element according to this invention.

FIG. 3 shows a diagram of the method for making the connection of elements which form part of aeronautical structures with other thermoplastic or thermoplastic reinforced elements, also pertaining to aeronautical structures according to this invention.

### DETAILED DESCRIPTION OF THE INVENTION

This invention describes in a first aspect the connection by means of ultrasound welding elements 1 which form part of aeronautical structures (termed substrates) with said elements 1 made from composite material, with other thermoplastic elements 2 (termed fittings) also pertaining to aeronautical structures. Furthermore, according to the invention, said element 2 (fitting) may also be made of thermoplastic material containing some type of reinforcement such as, for example, occurs in fittings 2 of composite material with a thermoplastic matrix reinforced with glass fibre.

According to the invention, the element 1 is made from composite material and comprises a layer 3 of thermoplastic material, in the form of an interwoven mesh fabric with a very small aperture size, known as carrier, with this layer 3 being embedded in the structure of the most superficial layer of the composite material 1 with respect to the thermoplastic or reinforced thermoplastic element 2 on which the element 1 is to be connected. The mesh size 10 which makes up the layer 3 of thermoplastic material should be a size which permits the resin to flow through said layer 3 so that it is perfectly embedded within the structure of the element 1 of composite material and, at the same time it should provide the necessary points of connection in order to obtain a perfect connection, with these points of connection comprising nodes of the previously mentioned mesh (see FIG. 2), An example, which is in no way restrictive, of the magnitude of the aforementioned mesh size 10 may oscillate between 0.20 and 0.25 mm.

FIG. 2 shows in a detailed cross section, in which the fibres of composite material of the element 1 which are situated at 90°, how the layer 3 of thermoplastic material is embedded in said element 1.

In the specific case that the element 2 (fitting) which is to be connected to another element of the aeronautical structure 1 (substrate) is of a metal type, said element 2 shall include, according to the invention, a layer of thermoplastic material with said layer of thermoplastic material adhering to the external surface of the aforementioned element 2 with respect to element 1 with which said element 2 is to be connected, thus it will again be in a similar case to that described previously.

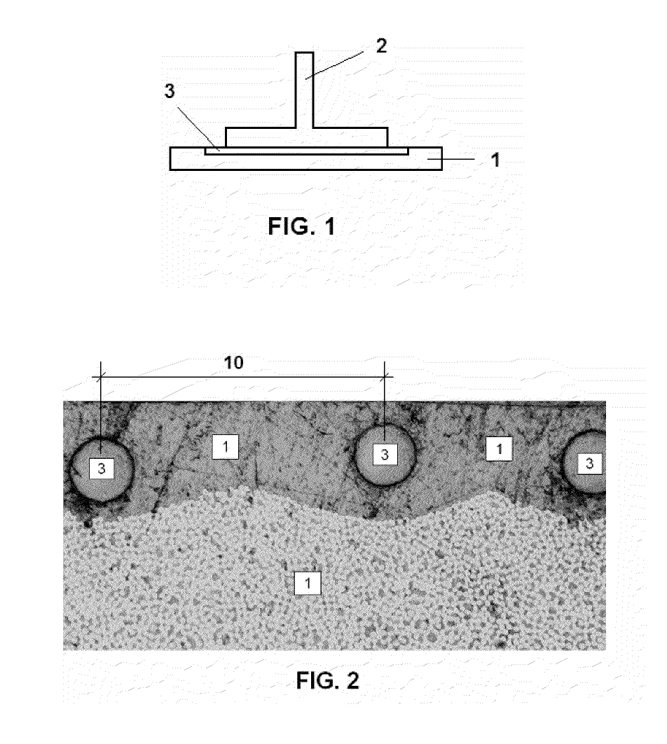

Subsequently this element 1 of composite material with a layer 3 of thermoplastic material embedded in its structure connects with the other thermoplastic or reinforced thermoplastic element 2 by means of an ultrasound welding process, thus making a permanent stable connection, however, one which at the same time can be extracted, thus obtaining a unitary type part such as that shown in FIG. 1.

The fact that element 1 includes a layer 3 of thermoplastic material makes it possible to use ultrasound welding to join it to another thermoplastic or reinforced thermoplastic element 2, as the elements 2 and 3 to be joined are of the same type.

In addition, in the case of elements 1 of composite material, since the layer 3 of thermoplastic material is embedded in the structure of said element 1, the problem of detachment of the connection is avoided since ultrasound welding is used.

The layer 3 of thermoplastic material permits element 1 of the aeronautical structure to be connected to another element 2, to be made from thermosetting, thermoplastic, or either a combination of thermoplastic and material and thermosetting material.

As mentioned, element 1 of composite material comprises a layer 3 of thermoplastic material in the form of interwoven fabric with this layer 3 embedded in the surface of said element 1 during its curing process, for subsequent ultrasound welding of the other element 2 of thermoplastic or reinforced thermoplastic material to which it is to be connected. This element 2 is of the same chemical nature as the aforementioned interwoven fabric which makes up the previous layer 3.

The aforementioned layer 3 is customarily known as a carrier because it is usually employed as a “support” for fluid adhesive products which, due to capillarity through its small openings (the mesh size apertures) propitiates and facilitates a good extension of said fluid product in the adhesive processes. The aforementioned layer 3 (or carrier) is a thermoplastic material which is light and which is embedded on top of the last of the carbon fibre fabrics on the base of which the composite material of element 1 is formed, in the event that this is a composite material. The pertinent curing process is applied to the material of the layer 3 together with the element 1, so that it hardens and remains embedded in the element 1. An example, which is not restrictive, of a micrograph illustrative of the position of the layer 3 or carrier with respect to the carbon fibres of element 1 is shown in FIG. 2, as mentioned above.

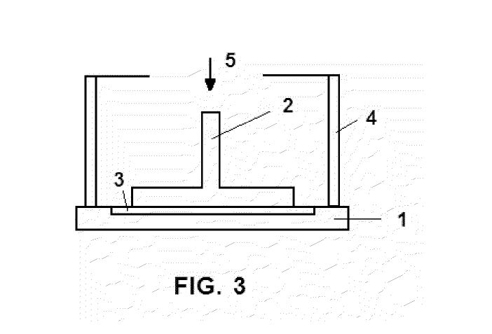

Subsequently, when the layer 3, element 1 and element 2 are solidly connected, the elements are ultrasound welded so that they will remain permanently connected and yet at the same time their extraction will be feasible. In said welding process there is no fusion and the welding is obtained by applying pressure and heat through the friction of the surfaces to be connected until the casting temperature of the material is reached due to rubbing and pressure exercised. As there is no fusion, this technique permits dissimilar materials to be connected. In ultrasound welding friction is obtained through application of oscillatory pressures cased by shock waves which act on the surfaces to be joined with ultrasonic frequency. Said oscillation causes an intimate contact, thus obtaining the connection. The heat generated is much lower than fusion temperatures of the material and, therefore, no type of protection is needed for the welding. In order to apply vibration, a device is used which includes a transducer which in turn converts electrical energy into a high frequency vibratory movement applied in the direction 5 by means of an adaptor 4, as represented in the diagram in FIG. 3. The pressures required are low and used to connect small thicknesses and soft materials, such as, for example, occurs with polymers (thermoplastic materials), aluminium or copper, from among metal materials.

In the specific case that element 1 is a composite material which comprises sufficient amount of thermoplastic material, with said part of thermoplastic material being arranged on the structure of element 1 of the composite materials, it is possible to make the connection of said element 1 with element 2 of thermoplastic or reinforced thermoplastic material in a direct manner, using ultrasound welding, without any need for the element 1 to include the layer 3 (carrier) of thermoplastic material.

According to a second aspect, the invention refers to a method for carrying out the connection of elements 1 which make up aeronautical structures with said elements 1 made from composite material, with other thermoplastic or reinforced thermoplastic elements 2 also pertaining to aeronautical structures. This method comprises the following stages:
a) positioning a layer 3 of thermoplastic material on the external surface of the element 1 of composite material prior to the process of manufacturing of said element 1, in such a way that following the curing process, said layer 3 remains embedded in the element 1;
b) preparation of the external surface of the element 1 of composite material;
c) connection, by means of ultrasound welding, through the layer 3 of thermoplastic material of the element 1 of the aeronautical structure with another element 2, applying a vibration in the direction 5 of high frequency by means of a device comprising a transducer which in turn becomes electrical energy in a high frequency vibratory movement, applied in direction 5 by means of an adaptor 4;
d) Extraction, if necessary, of the aforementioned element 2 and ultrasound welding of said element 2 in a new position.

In the embodiments we have described, those modifications included in the scope defined by the following claims may be introduced.

1. Connection of elements (1) which form part of aeronautical structures, with said elements (1) made in composite material, with other thermoplastic or reinforced thermoplastic elements (2) also pertaining to aeronautical structures, characterised in that said element (1) comprises at least one part of its structure made from thermoplastic material, with said part of thermoplastic material arranged on the structure of the most superficial layer of the element (1) of composite material, with respect to the thermoplastic or reinforced thermoplastic element (2) to which it is to be connected, so that the connection between the elements (1,2) is made by means of ultrasound welding without fusion, applying pressure and heat through friction of the surfaces of the elements to be connected (1,2), obtaining in this way a permanent connection of the elements (1, 2) with its extraction being possible at the same time.

2. Connection of elements (1) according to claim 1, in which the element (1) of composite material comprises a layer (3) of thermoplastic material in the form of an interwoven fabric mesh, with said layer (3) embedded in the structure of the most superficial layer of the element (1) with respect to the thermoplastic or reinforced thermoplastic element (2).

3. Connection of elements (1) according to claim 2, in which the layer (3) of thermoplastic material in the form of an interwoven fabric mesh has a mesh size (10) which permits the resin to flow through said layer (3) in such a way that said layer (3) remains perfectly embedded in the structure of the element (1).

4. Connection of elements (1) according to claim 3, in which the mesh size (10) of the mesh which makes up the layer (3) has a value between 0.20 and 0.25 mm.

5. Connection of elements (1) according to claim 3, in which the mesh which makes up the layer (3) comprises nodes which serve as connection points in order to obtain perfect connection of the layer (3) in the structure of the element (1).

6. Connection of elements (1) according to claim 1, in which the element (1) is made from thermosetting material, or of a combination of thermosetting material and thermoplastic material.

7. Method for carrying out the connection of elements (1) which form part of aeronautical structures with said elements (1) made from composite material, with other thermoplastic or reinforced thermoplastic elements (2) also pertaining to aeronautical structures, characterised in that said method comprises the following stages:
a) preparation of the external surface of the element (1) of composite material, which comprises a part of the structure of its external surface made from thermoplastic material;
b) connection by means of ultrasound welding without fusion of the external surface of the element (1) with the external surface of the other thermoplastic or reinforced thermoplastic element (2).

8. Method for carrying out the connection of elements (1) according to claim 7 which comprises, in addition, a stage prior to stage a) in which a layer (3) of thermoplastic material is positioned on the external surface of the element (1) of composite material, prior to the manufacturing process of said element (1), in such a way that, following a curing process, said layer (3) is embedded in the element (1).

9. Method for carrying out the connection of elements (1) according to claim 7, which in stage b) the connection by means of ultrasound welding of the element (1) of the aeronautical structure with the other thermoplastic or reinforced thermoplastic element (2) is made by applying a vibration in a direction (5) of high frequency by means of a device which comprises a transducer which in turn converts the electrical energy into a vibratory movement of high frequency applied in the direction (5) by means of an adaptor (4).

10. Method for carrying out the connection of elements (1) according to claim 5 which comprises furthermore, after stage b), a stage in which the thermoplastic or reinforced thermoplastic element (2) is extracted, subsequently connecting said element (2) by means of ultrasound welding, in a new position.

11. Connection of elements (1) according to claim 4, in which the mesh which makes up the layer (3) comprises nodes which serve as connection points in order to obtain perfect connection of the layer (3) in the structure of the element (1).

12. Connection of elements (1) according to claim 2, in which the element (1) is made from thermosetting material, or of a combination of thermosetting material and thermoplastic material.

13. Connection of elements (1) according to claim 3, in which the element (1) is made from thermosetting material, or of a combination of thermosetting material and thermoplastic material.

14. Connection of elements (1) according to claim 4, in which the element (1) is made from thermosetting material, or of a combination of thermosetting material and thermoplastic material.

15. Connection of elements (1) according to claim 5, in which the element (1) is made from thermosetting material, or of a combination of thermosetting material and thermoplastic material.

16. Method for carrying out the connection of elements (1) according to claim 8, which in stage b) the connection by means of ultrasound welding of the element (1) of the aeronautical structure with the other thermoplastic or reinforced thermoplastic element (2) is made by applying a vibration in a direction (5) of high frequency by means of a device which comprises a transducer which in turn converts the electrical energy into a vibratory movement of high frequency applied in the direction (5) by means of an adaptor (4).

17. Method for carrying out the connection of elements (1) according to claim 6 which comprises furthermore, after stage b), a stage in which the thermoplastic or reinforced thermoplastic element (2) is extracted, subsequently connecting said element (2) by means of ultrasound welding, in a new position.

18. Method for carrying out the connection of elements (1) according to claim 7 which comprises furthermore, after stage b), a stage in which the thermoplastic or reinforced thermoplastic element (2) is extracted, subsequently connecting said element (2) by means of ultrasound welding, in a new position.
